(19) United States
(12) Patent Application Publication
(10) Pub. No.: US 2003/0048281 A1
(43) Pub. Date: Mar. 13, 2003

(54) Presentation system for handling image data larger than storing region of display device

(75) Inventors: Shinya Murai, Kanagawa (JP); Fumiko Muraui, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/238,718

(22) Filed: Sep. 11, 2002

(30) Foreign Application Priority Data
Sep. 13, 2001 (JP) 2001-277433

(51) Int. Cl. G09G 5/00

(52) U.S. Cl. 345/620

(57) ABSTRACT

In a presentation system to be utilized in conducting a presentation by displaying image data for the presentation, the control device determines deletion target image data to be deleted among those image data that are already stored in a storing unit of the display device when a size of an image data to be transmitted is larger than a storing region size available at the storing unit of the display device and notifies information on the deletion target image data to the display device, such that the deletion target image data are deleted from the storing unit according to the information notified from the control device.

### BACKGROUND OF THE INVENTION

1. Field of the Invention

The present invention relates to a presentation system for displaying presentation image data on a display device according to commands of a control device.

2. Description of the Related Art

A presentation system capable of conducting a presentation by displaying or reproducing image information or sound information stored in electronic information recording media such as magnetic disks (HDD, FDD) is disclosed in Japanese Patent Application Laid Open No. 2001-103439, for example.

Using this presentation system, it is possible to conduct a presentation by transmitting a plurality of image data for presentation from a control device to a display device connected through a network, and displaying these image data on the display device according to commands from the control device.

However, in this presentation system, when an image data storing region provided in the display device is smaller than a size (information amount) of the image data to be used for the actual presentation, it has been impossible to store all the image data in the storing region of the display device. In such a case, the control device side that transmits the image data cannot recognize in advance that it is impossible to store all the image data to be used for the presentation because the size of the storing region on the display device side is insufficient, so that there has been a problem that it becomes impossible to transmit the image data in a middle of the presentation and it becomes impossible to conduct the presentation as a result.

As described, in the conventional presentation system, when the storing region of the display device is smaller than a size of the image data to be used for the presentation, the user cannot recognize in advance that it is impossible to store all the image data to be used for the presentation so that there has been a problem that it becomes impossible to transmit the image data in a middle of the presentation.

### BRIEF SUMMARY OF THE INVENTION

It is therefore an object of the present invention to provide a presentation system capable of transmitting the presentation image data even when a size of the storing region on the display device is not sufficiently large.

In short, this is realized by acquiring a size of the storing region available at the display device, judging whether it is possible for the display device to store the image data scheduled to be transmitted or not according to that information, determining the image data to be deleted among those already stored in the storing region of the display device according to that judgement result, and deleting these image data specified from the control device.

According to one aspect of the present invention there is provided a presentation system to be utilized in conducting a presentation by displaying image data for the presentation, comprising: a control device having an image data storing unit configured to store the image data and a transmitting unit configured to transmit the image data stored in the image data storing unit; and at least one display device having a storing unit configured to store the image data transmitted from the control device and a display unit configured to display the image data stored in the storing unit; wherein the control device has a control unit configured to determine deletion target image data to be deleted among those image data that are already stored in the storing unit of said at least one display device when a size of an image data to be transmitted is larger than a storing region size available at the storing unit of said at least one display device and to notify information on the deletion target image data to said at least one display device; and said at least one display device has a unit configured to delete the deletion target image data from the storing unit according to the information notified from the control device.

According to another aspect of the present invention there is provided a method of conducting a presentation by displaying image data for the presentation by using a presentation system formed by a control device having an image data storing unit configured to store the image data and a transmitting unit configured to transmit the image data stored in the image data storing unit, and at least one display device having a storing unit configured to store the image data transmitted from the control device and a display unit configured to display the image data stored in the storing unit, the method comprising: determining deletion target image data to be deleted among those image data that are already stored in the storing unit of said at least one display device when a size of an image data to be transmitted is larger than a storing region size available at the storing unit of said at least one display device and notifying information on the deletion target image data to said at least one display device, at the control device; and deleting the deletion target image data from the storing unit according to the information notified from the control device, at said at least one display device.

According to another aspect of the present invention there is provided a control device for a presentation system to be utilized in conducting a presentation by displaying image data for the presentation at at least one display device, the control device comprising: an image data storing unit configured to store the image data; a transmitting unit configured to transmit the image data stored in the image data storing unit; and a control unit configured to determine deletion target image data to be deleted among those image data that are already stored in a storing unit of said at least one display device when a size of an image data to be transmitted is larger than a storing region size available at the storing unit of said at least one display device and to notify information on the deletion target image data to said at least one display device, such that the deletion target image data is deleted from the storing unit of said at least one display device according to the information notified from the control device.

According to another aspect of the present invention there is provided a computer program product for causing a computer to function as a control device for a presentation system to be utilized in conducting a presentation by displaying image data for the presentation at at least one display device, the computer program product comprising: a first computer program code for causing the computer to store the image data in an image data storing unit; a second computer program code for causing the computer to transmit the image data stored in the image data storing unit; and a third computer program code for causing the computer to determine deletion target image data to be deleted among those image data that are already stored in a storing unit of said at least one display device when a size of an image data to be transmitted is larger than a storing region size available at the storing unit of said at least one display device and to notify information on the deletion target image data to said at least one display device, such that the deletion target image data is deleted from the storing unit of said at least one display device according to the information notified from the control device.

Other features and advantages of the present invention will become apparent from the following description taken in conjunction with the accompanying drawings.

### BRIEF DESCRIPTION OF THE DRAWINGS

FIG. 1 is a block diagram showing an exemplary configuration of a presentation system according to the first embodiment of the present invention.

FIG. 2 is a diagram showing exemplary attribute information for image data stored in a storing unit of a control device in the presentation system of FIG. 1.

FIG. 3 is a flow chart for a presentation method to be carried out by the presentation system of FIG. 1.

FIG. 4 is a block diagram showing an exemplary configuration of a presentation system according to the second embodiment of the present invention.

FIG. 5 is a schematic diagram showing a concrete exemplary configuration of the presentation system according to the second embodiment of the present invention.

FIG. 6 is a block diagram showing an exemplary configuration of a presentation system according to the third embodiment of the present invention.

FIG. 7 is a diagram showing an exemplary display at a display unit of a control device in the presentation system of FIG. 6.

### DETAILED DESCRIPTION OF THE INVENTION

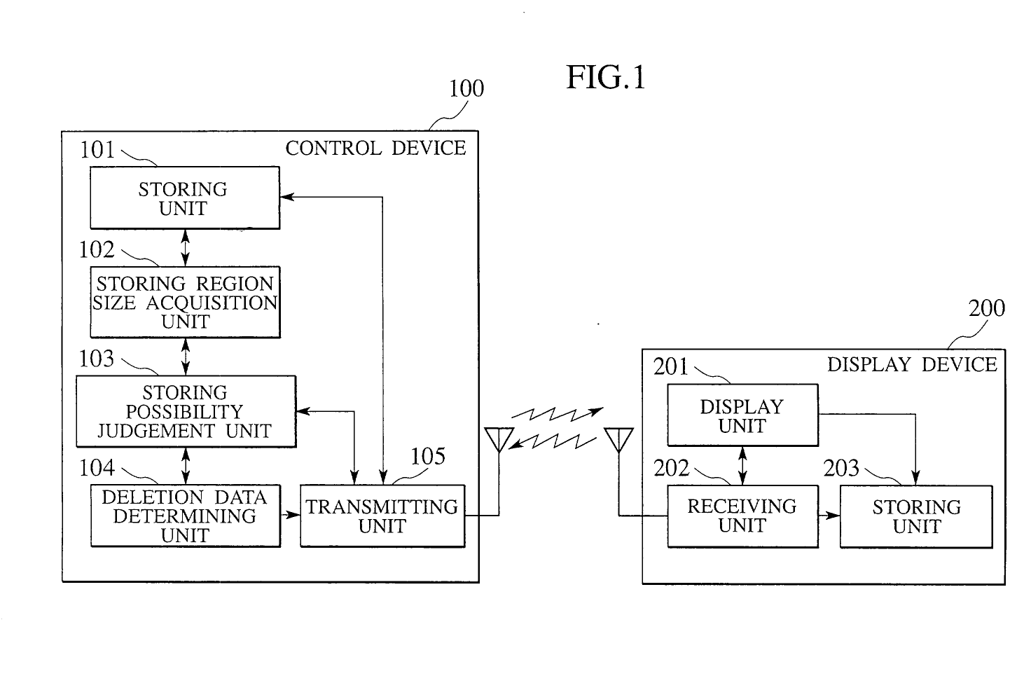

Referring now to FIG. 1 to FIG. 3, the first embodiment of a presentation system according to the present invention will be described in detail.

In this embodiment, a presentation system having a display device for receiving and displaying image data and a control device for controlling transmission and display of the image data is provided with a function for controlling transmission, storing and display of the image data for presentation according to a size of an image data storing region available at the display device that is a receiver of the image data.

FIG. 1 shows an exemplary configuration of the presentation system according to the first embodiment.

This presentation system comprises a control device 100 and a display device 200. The control device 100 is an information processing device to be utilized by a presentor (or an operator) of the presentation, and has a storing unit 101 for storing image data, a transmission unit 105 for transmitting the image data and the like, a storing region size acquisition unit 102, a storing possibility judgement unit 103, and a deletion data determining unit 104. The display device 200 is an information processing device to be used for audience of the presentation, and has a receiving unit 202 for receiving the image data for the presentation, a storing unit 203 for storing the image data, and a display unit 201 for displaying the image data.

The storing unit 101 is formed by an information recording medium such as a semiconductor memory, a magnetic disk device, an optical disk device, or a magneto-optic disk device, for example, and stores the image data to be used for the presentation as well as data attribute information such as an information amount (data size) of the image data, a state of transmission to the display device 200 (already transmitted or not yet transmitted), etc., in relation to the image data.

The storing region size acquisition unit 102 acquires a size of the storing region available at the storing unit 203 of the display device 200. There can be cases where the storing region size of the storing unit 203 is known in advance before the transmission of the image data as the display device 200 is known to the control device 100, but in the case where the display device 200 is unknown, this size can be acquired by inquiring the image data storing region size from the control device to the display device before the transmission of the image data. The storing region size acquisition unit 102 can acquire the currently available storing region size by subtracting the data size of the already transmitted image data from the storing region size of the storing unit 203 of the display device 200 before storing any data (initial value).

The storing possibility judgement unit 103 judges whether it is possible for the storing unit 203 of the display device 200 to store the image data to be transmitted or not, according to the storing region size acquired by the storing region size acquisition unit 102. More specifically, the currently available storing region size of storing unit 203 of the display device 200 and a size of the image data to be transmitted by the control device 100 are compared, and it is judged that the image data are “possible to store” when the storing region size of the storing unit 203 is not smaller than the image data size, and it is judged that the image data are “impossible to store” when the image data size is larger than the storing region size of the storing unit 203.

In the case of “impossible to store”, in order to secure the storing region for the image data to be received and displayed from now, the deletion data determining unit 104 determines the image data to be deleted among the image data stored in the storing unit 203 of the display device 200 according to the judgement result of the storing possibility judgement unit 103. More specifically, the image data to be deleted are selected and determined such that the storing region size of the storing unit 203 of the display device 200 becomes larger than the size of the image data to be transmitted from now by the control device 100. The method for selecting the image data to be deleted will be described below.

The transmission unit 105 transmits the image data to be used for the presentation, as well as a display request message information for requesting the display of the image data to the display device 200, a deletion request message information for indicating the image data determined by the deletion data determining unit 104, etc., to the receiving unit 202 of the display device 200, according to commands of a presentor.

The receiving unit 202 of the display device 200 receives the image data, the display request message information for requesting the display of the image data, and the deletion request message information for indicating the image data to be deleted, which are transmitted from the control device 100. The storing unit 203 is formed by an information recording medium such as a semiconductor memory, a magnetic disk device, an optical disk device, or a magneto-optic disk device, for example, and stores the image data for the presentation received by the receiving unit 202. When requested from the control device 100, the image data specified by the deletion request message is deleted from the storing unit 203.

The display unit 201 retrieves the image data from the storing unit 203 according to the display request message received by the receiving unit 202, and displays that image.

Now, a concrete exemplary operation procedure of the presentation system will be described in detail.

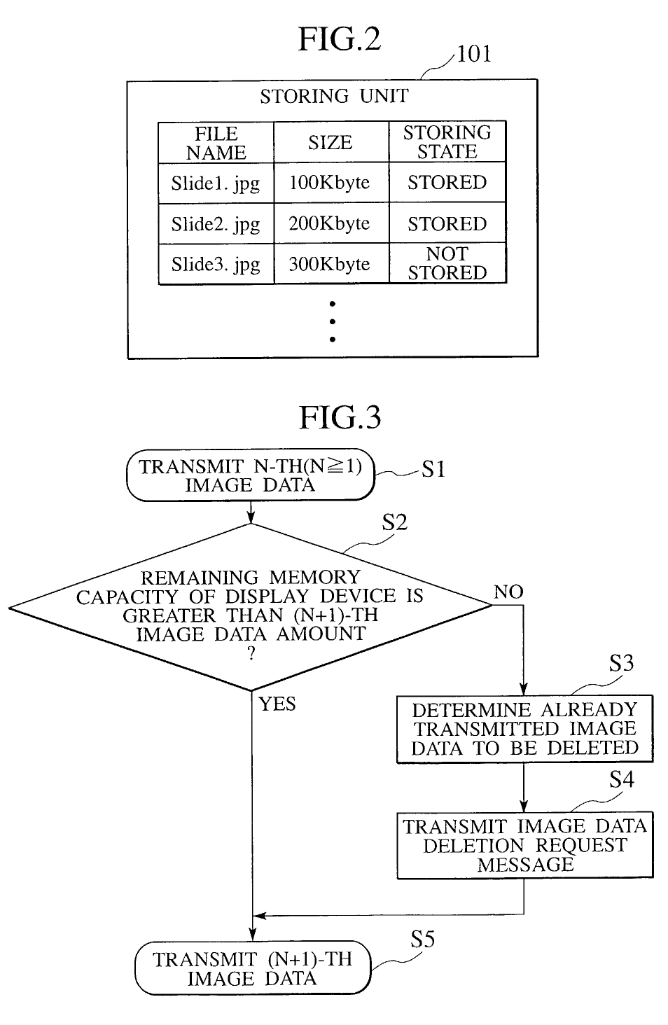

When the image data to be sent to the display device 200 are specified from the operator of the control device 100, the transmission unit 105 reads out the attribute information of the image data stored in the storing unit 101 in order to determine the transmission data to be transmitted to the display device 200. The storing unit 101 stores the image data to be transmitted as well as the attribute information such as information on links to the image data (such as image file names), sizes (information amounts) of the image data, storing states (already stored or not yet stored) at the display device (see FIG. 2). Note that the attribute information of the image data may also be acquired from the display device 200 by the control device 100 through the network whenever necessary.

When the storing state at the display device 200 of the image data is “already stored” upon referring to the attribute information of the image data to be displayed, the transmission unit 105 sends the display request message information for that image data to the display device 200. Upon receiving the display request message information, the receiving unit 202 issues the display request for that image data to the display unit 201. The display unit 201 retrieves the image data specified by that message from the storing unit 203 and displays that image.

On the other hand, when the storing state at the display device 200 of the image data is “not yet stored” upon referring to the attribute information of the image data to be displayed, the transmission unit 105 requests the storing possibility judgement unit 103 to judge whether it is possible to store that image data in the display device 200 or not. The storing possibility judgement unit 103 acquires the storing region size available at the display device 200 from the storing region size acquisition unit 102, and compares it with the size of the specified image data. More specifically, the storing region size acquisition unit 102 stores the storing region size of the display device 200 at a start of the presentation, and calculates the currently available remaining storing region size by subtracting the total size of the image data already sent to the display device 200 from this storing region size.

When the storing possibility judgement unit 103 judges that the image data to be transmitted is “possible to store”, the transmission unit 105 acquires the image data from the storing unit 101 and sends it to the display device 200.

On the other hand, when the storing possibility judgement unit 103 judges that the image data is “impossible to store” as the available storing region size of the storing unit 203 of the display device 200 is smaller than the size of the image data to be transmitted, in order to secure the storing region necessary for storing that image data, the transmission unit 105 requests the deletion data determining unit 104 to determine the image data to be deleted from the already transmitted image data. For example, the deletion data determining unit 104 determines the image data to be deleted sequentially from the image data for which the time of transmission to the display device 200 is the oldest among the image data to be used for the presentation, according to the storing unit 101.

Note that there are other methods for determining the image data to be deleted besides the above described one, such as those in which the image data to be deleted are selected and determined according to criteria such as: (1) an order of sizes of the image data (the image data with a larger data size is deleted before the others), (2) an order of display among the already displayed image data to be used for the presentation that are stored in the display device 200 (the image data displayed earlier in the presentation is deleted before the others), (3) an order of the priority levels in the presentation (the image data describing the bibliographical matters such as a title or the contents of the presentation is deleted before the others), etc.

The transmission unit 105 transmits the deletion request message information for the image data determined according to such criteria to the display device 200. When the receiving unit 202 of the display device 200 receives the deletion request message for the image data, the display device 200 deletes that image data that is stored in the storing unit 203. After transmitting the deletion request message for that image data, the transmission unit 105 of the control device 100 transmits the image data for which the display is specified by the operator of the control device 100.

Upon receiving the image data, the receiving unit 202 of the display device 200 sends the received image data to the storing unit 203, and the storing unit 203 stores the received image data. The receiving unit 202 then requests the display unit 201 to display that image data according to the display request message from the control device 100, and the display device 201 displays the image data.

In this way, it becomes possible to provide the presentation system which is capable of transmitting the image data for the presentation regardless of the size of the storing region in the display device 200.

In this embodiment, the control device 100 can be provided in a form of a portable information terminal (personal digital assistant (PDA)), a personal computer (PC) or the like. Also, the display device 200 can be provided in a form of a projector for projecting images on a white screen, a PC connected to the projector for the purpose of the presenter to monitor the projected images, a large screen digital TV set that can be watched by the audience, or some other kind of PC.

By utilizing this presentation system, it is possible for the presenter of the presentation to send the image data for the presentation stored in the control device 100 as well as the control signals for controlling the display of the image data to the display device 200 that can be utilized by the audience, and also to conduct the presentation by displaying the image data for the presentation in synchronization at a plurality of the display devices 200.

Note that the image data for the presentation can be image data for slides prepared by the presenter by using a presentation production tool or image production tool, image files taken by a digital camera or digital video, image files read by an image scanner, etc.

Next, a method of presentation utilizing the presentation system of this embodiment will be described.

FIG. 3 shows a flow chart for this method. The control device 100 transmits the N-th (N≧1) image data (step S101). Then, prior to transmitting the (N+1)-th image data, the control device 100 judges whether it is possible to transmit the (N+1)-th image data or not, that is, whether it is possible for the receiving device to receive and store the (N+1)-th image data or not. More specifically, whether the remaining memory capacity of the storing unit 203 provided at the display device 200 is larger than or equal to the data amount of the (N+1)-th image data or not is judged (step S102).

Here, when the remaining memory capacity of the storing unit 203 is larger than or equal to the data amount of the (N+1)-th image data, it is judged as “possible to transmit” or “possible to store”, and the control device 100 transmits the (N+1)-th image data (step S103). On the other hand, when the remaining memory capacity if the storing unit 203 is smaller than the data amount of the (N+1)-th image data, it is judged as “impossible to transmit” or “impossible to store”, and the operation to expand the storing region size of the storing unit 203 of the display device 200 is carried out.

More specifically, the image data to be deleted among the image data already stored in the storing unit 203 of the display device 200 are determined (step S104). The criteria for determining the image data to be deleted can be those described above. When the image data to be deleted are determined, the control device 100 transmits the deletion request message for these image data (step S105). Then, the control device 100 transmits the (N+1)-th image data (step S103) such that even when the remaining memory capacity of the storing unit 203 of the display device 200 is insufficient, it becomes possible to conduct the presentation by expanding the storing region size as much as necessary and storing the (N+1)-th image data into the storing unit 203 of the display device 200.

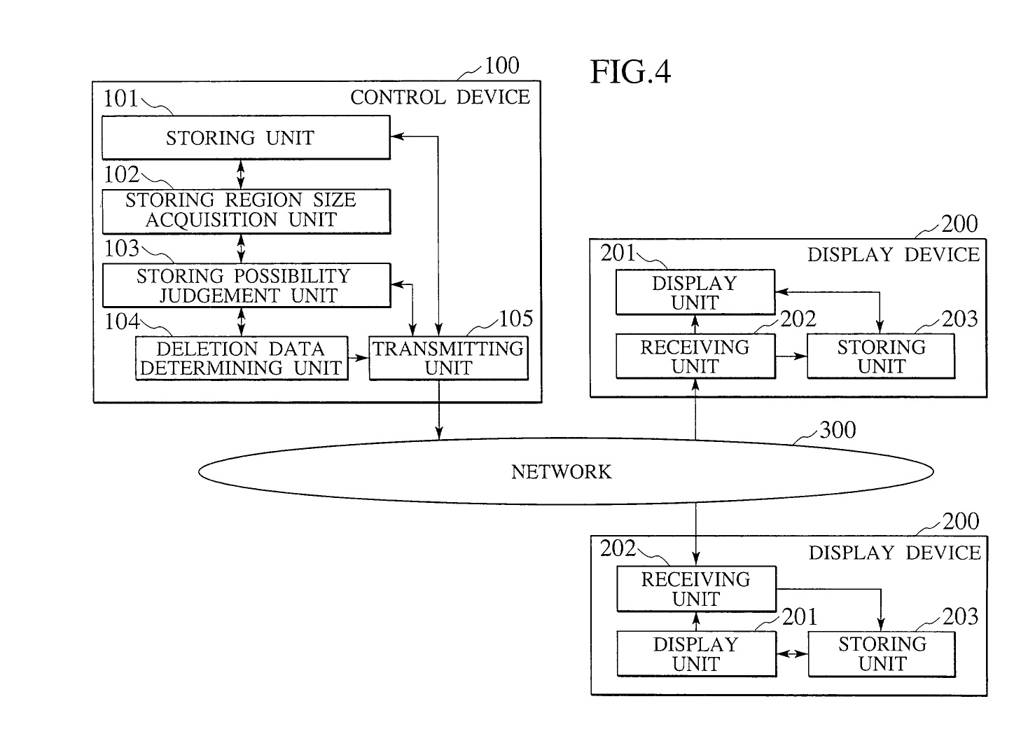

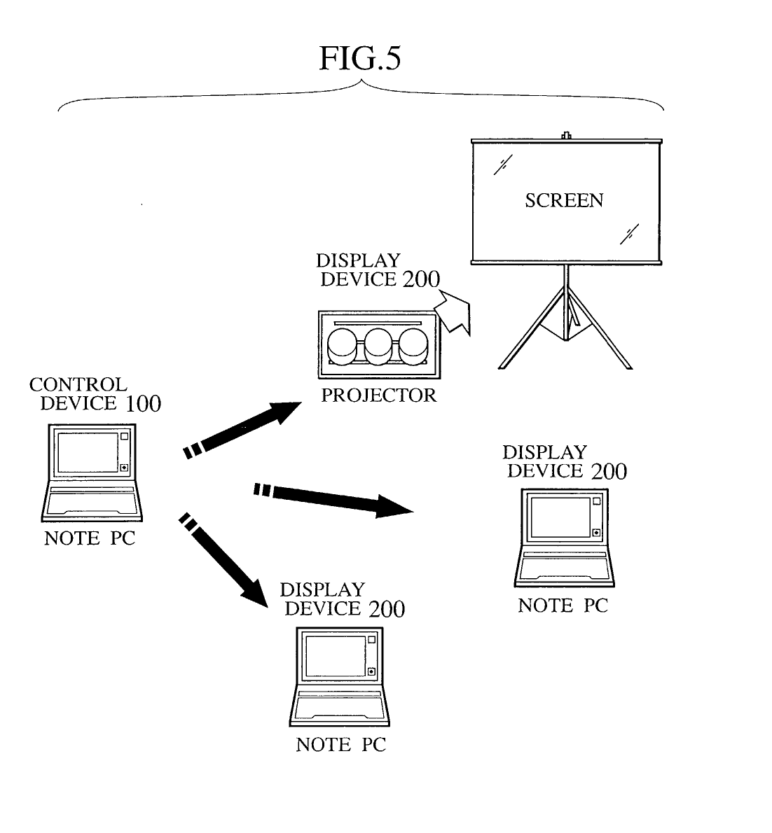

Referring now to FIG. 4 and FIG. 5, the second embodiment of a presentation system according to the present invention will be described in detail.

In this embodiment, a presentation system having a plurality of display devices for receiving and displaying image data and a control device for controlling transmission and display of the image data is provided with a function for controlling transmission of the image data for presentation according to sizes of image data storing regions of the plurality of display devices that are receivers of the image data for presentation.

FIG. 4 shows an exemplary configuration of the presentation system according to the second embodiment.

This presentation system comprises a control device 100 and display devices 200 which are connected through a network 300. The configuration of FIG. 4 differs from that of the first embodiment in that a plurality of display devices 200 are connected to the control device 100 through the network 300.

In this embodiment, the control device 100 is an information processing device to be utilized by a presenter of the presentation, which is provided in a form of a PDA, PC or the like in practice. Each display device 200 is an information processing device to be used by the audience of the presentation, which is provided in a form of a projector, PC connected to the projector, digital TV, PC or the like. The network 300 is a network in a form of a LAN (Local Area Network) using the Ethernet or the like, WAN (Wide Area Network) in which networks are interconnected by a public network, IrDA (Infrered Data Association), or a network using serial cables and parallel cables for directly connecting among computers. The physical configuration of this network can be either wired or wireless. Note that FIG. 4 shows an exemplary configuration in which two display devices 200 are connected to the control device 100 through the network 300, but it is also possible to connect three or more display devices 200 simultaneously.

In this embodiment, it is possible for the presentor of the presentation (or the operator of the control device 100) to send the image data for the presentation stored in the control device 100 to the plurality of display devices 200 that are utilized by the audience through the network 300, and also to conduct the presentation by displaying the image data for the presentation in synchronization at the plurality of display devices 200.

The control device 100 and the display devices 200 can have the similar configurations as the control device 100 and the display device 200 used in the first embodiment. Here, the plurality of display devices 200 may be provided as devices of the similar type (such as a plurality of image projector devices that are connected in parallel and arranged, for example) or as devices of different types (such as a combination of an image projector device and a digital TV set or a combination of an image projector and a PC with an image display, for example).

In the case of connecting the plurality of display devices 200 to the control device 100 through the network 300, when the sizes of the storing regions of the storing units provided in the plurality of display devices 200 are the same, it is possible to transfer and display the image data while checking the available storing region size by the method similar to that of the first embodiment.

On the other hand, when the sizes of the storing regions of the storing units provided in the plurality of display devices 200 connected to the network are different, the image data transfer is carried out by the following method.

Namely, when the plurality of display devices 200 exist, the available storing region size of each one of the plurality of display devices 200 is checked and whether it is possible to transmit and store the image data or not is judged according to the storing region size of the storing unit that has the smallest available storing region size among the plurality of display devices 200.

Note that there can be cases where the available storing region size of the storing unit 203 of the display device 200 during the presentation changes by the data size (information amount) of data other than the stored image data. In such cases, it is possible to realize the image data transfer by acquiring the available storing region size from the display device 200 through the network 300 at each occasion of the image data transfer or regularly.

FIG. 5 shows a concrete exemplary configuration of the presentation system formed by a combination of realistic control device and display devices. In this example, the control device 100 is provided in a form of a portable PC (Note PC), while the display devices 200 are provided in forms of a projection type image projector for projecting images on a white screen and portable PCs (Note PCs). These control device and display devices carry out the data transmission and reception through radio interfaces such as the Bluetooth.

The image data for the presentation are stored in the control device 100, and when the operator operates the control device 100, the image data are transmitted to the display devices 200 and the images are displayed at these display devices 200. When the image storing region of the image projector that constitutes the display device 200 is smaller than the image storing region of the PC that constitutes the control device 100, there can be cases where it is impossible to store all the image data for the presentation as stored in the PC that constitutes the control device 100 into the image storing region of the image projector. The similar problem may also arise when a capacity of the storing region (HDD, for example) of the PC that constitutes the display device 200 is smaller than a capacity of the storing region (HDD, for example) of the PC that constitutes the control device 100.

In such cases, the image data transfer is carried out while the control device 100 monitors the available storing region size of the display device 200, and when the storing region size of the display device 200 becomes insufficient temporarily, the available storing region is secured by determining the image data to be deleted and deleting the image data already stored in the display device 200, such that it becomes possible to store and display the new image data. In this embodiment, the functions of the image data transmission, the displaying, the storing region size acquisition, the storing possibility judgement, the deletion data determination, etc., can be realized by using software (computer program) installed in the PCs.

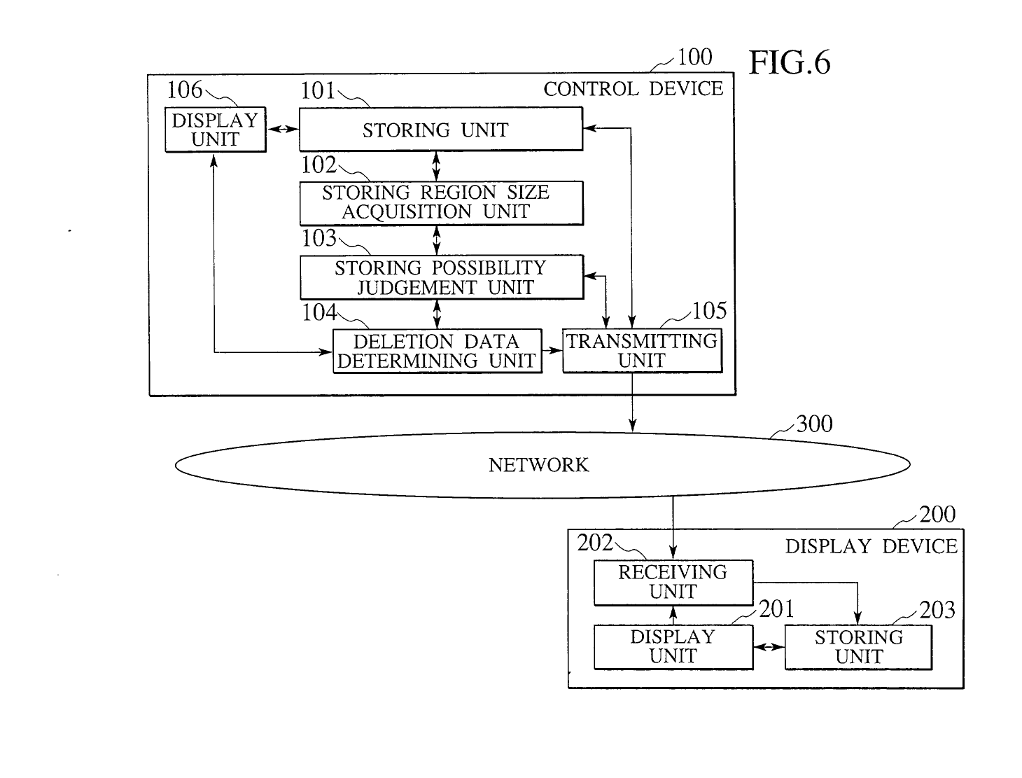

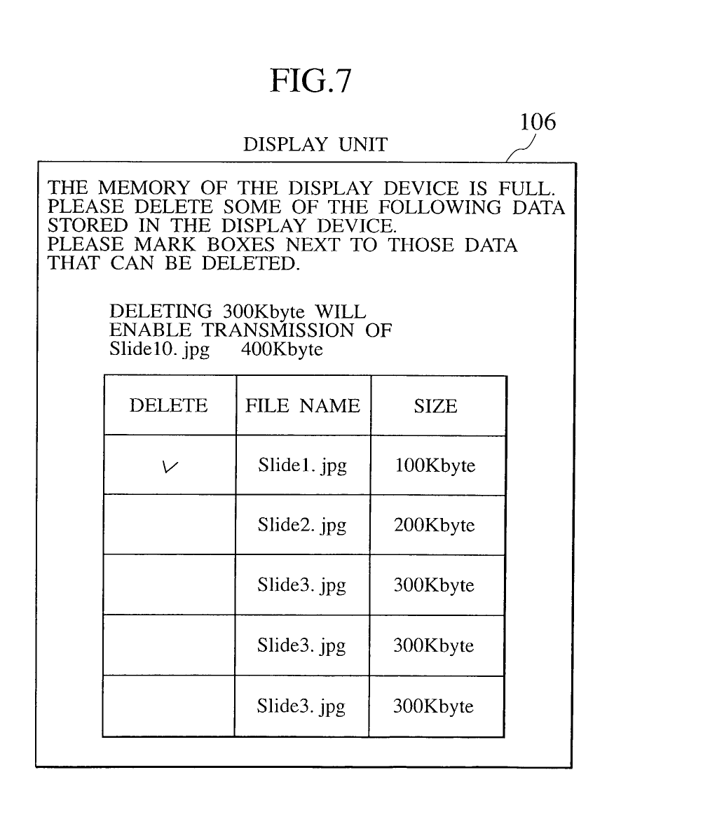

Referring now to FIG. 6 and FIG. 7, the third embodiment of a presentation system according to the present invention will be described in detail.

FIG. 6 shows an exemplary configuration of the presentation system according to the third embodiment.

In this presentation system, the control device 100 has a storing unit 101, a transmission unit 105, a storing region size acquisition unit 102, a storing possibility judgement unit 103, a deletion data determining unit 104, and a display unit 106. Here, the storing unit 101, the transmission unit 105, the storing region size acquisition unit 102, the storing possibility judgement unit 103 and the deletion data determining unit 104 are the same as those of the first and second embodiments. The display device 200 has a receiving unit 202, a storing unit 203, and a display unit 201. This display device 200 is the same as that of the first and second embodiments.

The display unit 106 of the control device is provided for displaying a transmission/storing state and a deletion confirmation for the image data to be used by the presentation.

FIG. 7 shows an exemplary display of the display unit 106. For example, in the case of displaying a plurality of image data in the presentation, an image data name (or a file name) of each already transmitted and stored image data and its data size (or file size) are displayed in correspondence.

Here, when it is impossible for the control device to transmit the image data (or it is impossible for the display device to store the image data) as the available storing region size of the storing unit 203 of the display device 200 is smaller than the size (information amount) of the image data to be transmitted from now, the storing possibility judgement unit 103 of the control device 100 judges that the image data is impossible to store, and the transmission unit 105 of the control device 100 requests the deletion data determining unit 104 to determine the image data to be deleted. In order to determine the image data to be deleted, the deletion data determining unit 104 requests a display of a list of image data to be used in the presentation to the display unit 106.

The display unit 106 acquires the image data name, the image size, and the storing state at the display device 200 of the image data to be used in the presentation from the storing unit 101, and makes a list display. The operator of the control device 100 specifies the image data to be deleted from the image data already stored in the storing unit 203 of the display device 200. This operation to specify the image data to be deleted is repeated until the available storing region size becomes larger than the data size of the image data for which the display request is made (that is the image data to be transmitted from now).

In this way, the deletion data determining unit 104 determines the image data (or a group of image data) to be deleted. Then the transmission unit 105 transmits the deletion request message information for the image data so determined to the display device 200 through the network 300. When the receiving unit 202 of the display device 200 receives the deletion request message, the display device 200 deletes the specified image data, and releases the storing region occupied by them.

Then the transmission unit 105 transmits the image data for which the display is specified by the operator (the image data to be transmitted). Upon receiving the image data, the receiving unit 202 sends the received image data to the storing unit 203, and the storing unit 203 stores the received image data, while the display unit 201 displays the image data.

In this embodiment, in the case of making the list display of the image data, a contracted image of the image data for the presentation may also be displayed in correspondence to the image data name and the data size. In such a case, the image data to be deleted can be selected and determined while checking the content of the contracted image of the image data on the display unit 106. It is also possible to display the transmission/storing state of the image data (already transmitted or stored, or not yet transmitted or stored) in correspondence to the image data name and the data size as shown in FIG. 2.

Also, the display unit 106 of the control device 100 can make the list display of the image data by including the image data for which the display request is made by the operator (the image data to be transmitted from now). In such a case, when the operator selects the image data to be transmitted from now, the deletion data determining unit 104 determines that image data as the deletion data. Then the deletion data determining unit 104 requests the cancellation of the transmission of that image data to the transmission unit 105 so as to cancel the transmission.

Also, the display unit 106 of the control device 100 may be able to display information (data name, data size, storing state, contracted image) of the image data that are already transmitted and stored, even when there is no need to delete the image data to be used in the presentation at the display device 200. In such a case, the operator can ascertain which image data are currently stored in the display device 200 whenever necessary so that it becomes possible to conduct the presentation in accordance with the image data transfer state. Conventionally, there has been a problem that the transfer of the not yet stored image data to be displayed can take so much time that the presentation is interrupted in a middle because the operator cannot ascertain which image data are stored in the storing unit 203 of the display device 200, but this problem can be resolved in this case because it becomes possible for the operator to ascertain the image data transfer state whenever necessary.

As described, according to the present invention, it becomes possible to conduct the presentation smoothly by controlling the transmission method of the image data for the presentation even when a sufficiently large storing region for the image data cannot be secured at the display device.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, each one of the control device and the display device of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A presentation system to be utilized in conducting a presentation by displaying image data for the presentation, comprising:
a control device having an image data storing unit configured to store the image data and a transmitting unit configured to transmit the image data stored in the image data storing unit; and
at least one display device having a storing unit configured to store the image data transmitted from the control device and a display unit configured to display the image data stored in the storing unit;
wherein the control device has a control unit configured to determine deletion target image data to be deleted among those image data that are already stored in the storing unit of said at least one display device when a size of an image data to be transmitted is larger than a storing region size available at the storing unit of said at least one display device and to notify information on the deletion target image data to said at least one display device; and
said at least one display device has a unit configured to delete the deletion target image data from the storing unit according to the information notified from the control device.

2. The presentation system of claim 1, wherein said at least one display device includes a plurality of display devices, and
the control unit of the control device determines the deletion target image data when the size of the image data to be transmitted is larger than the storing region size available at the storing unit of one of the plurality of display devices which is smallest among storing region sizes available at storing units of the plurality of display devices.

3. The presentation system of claim 1, wherein the control unit also has an information display unit configured to display attribute information of the image data to be deleted.

4. The presentation system of claim 3, wherein the control unit of the control device determines the deletion target image data according to a selection made by an operator of the control device on the information display unit.

5. The presentation system of claim 1, wherein the control unit of the control device determines the deletion target image data according to an order of transmission times among the image data, an order of data sizes among the image data, an order of display among the image data, or an order of priority levels among the image data.

6. A method of conducting a presentation by displaying image data for the presentation by using a presentation system formed by a control device having an image data storing unit configured to store the image data and a transmitting unit configured to transmit the image data stored in the image data storing unit, and at least one display device having a storing unit configured to store the image data transmitted from the control device and a display unit configured to display the image data stored in the storing unit, the method comprising:
determining deletion target image data to be deleted among those image data that are already stored in the storing unit of said at least one display device when a size of an image data to be transmitted is larger than a storing region size available at the storing unit of said at least one display device and notifying information on the deletion target image data to said at least one display device, at the control device; and
deleting the deletion target image data from the storing unit according to the information notified from the control device, at said at least one display device.

7. The method of claim 6, wherein said at least one display device includes a plurality of display devices, and
the determining step determines the deletion target image data when the size of the image data to be transmitted is larger than the storing region size available at the storing unit of one of the plurality of display devices which is smallest among storing region sizes available at storing units of the plurality of display devices.

8. The method of claim 6, further comprising:
displaying attribute information of the image data to be deleted on an information display unit of the control device.

9. The method of claim 8, wherein the determining step determines the deletion target image data according to a selection made by an operator of the control device on the information display unit.

10. The method of claim 6, wherein the determining step determines the deletion target image data according to an order of transmission times among the image data, an order of data sizes among the image data, an order of display among the image data, or an order of priority levels among the image data.

11. A control device for a presentation system to be utilized in conducting a presentation by displaying image data for the presentation at at least one display device, the control device comprising:
an image data storing unit configured to store the image data;
a transmitting unit configured to transmit the image data stored in the image data storing unit; and
a control unit configured to determine deletion target image data to be deleted among those image data that are already stored in a storing unit of said at least one display device when a size of an image data to be transmitted is larger than a storing region size available at the storing unit of said at least one display device and to notify information on the deletion target image data to said at least one display device, such that the deletion target image data is deleted from the storing unit of said at least one display device according to the information notified from the control device.

12. The control device of claim 11, wherein said at least one display device includes a plurality of display devices, and
the control unit determines the deletion target image data when the size of the image data to be transmitted is larger than the storing region size available at the storing unit of one of the plurality of display devices which is smallest among storing region sizes available at storing units of the plurality of display devices.

13. The control device of claim 11, further comprising:
an information display unit configured to display attribute information of the image data to be deleted.

14. The control device of claim 13, wherein the control unit determines the deletion target image data according to a selection made by an operator of the control device on the information display unit.

15. The control device of claim 11, wherein the control unit determines the deletion target image data according to an order of transmission times among the image data, an order of data sizes among the image data, an order of display among the image data, or an order of priority levels among the image data.

16. A computer program product for causing a computer to function as a control device for a presentation system to be utilized in conducting a presentation by displaying image data for the presentation at at least one display device, the computer program product comprising:
a first computer program code for causing the computer to store the image data in an image data storing unit;
a second computer program code for causing the computer to transmit the image data stored in the image data storing unit; and
a third computer program code for causing the computer to determine deletion target image data to be deleted among those image data that are already stored in a storing unit of said at least one display device when a size of an image data to be transmitted is larger than a storing region size available at the storing unit of said at least one display device and to notify information on the deletion target image data to said at least one display device, such that the deletion target image data is deleted from the storing unit of said at least one display device according to the information notified from the control device.
